(19) United States
(12) Patent Application Publication
(10) Pub. No.: US 2016/0123571 A1
(43) Pub. Date: May 5, 2016

(54) ILLUMINATION APPARATUS INCLUDING TUBULAR HEAT SINK FOR FACILITATING COOLING BY AIR CONVECTION OR FORCED AIR

(71) Applicants: Eric P. P. Chan, New York, NY (US); Kevin Y. H. Chan, New York, NY (US)

(72) Inventors: Eric P. P. Chan, New York, NY (US); Kevin Y. H. Chan, New York, NY (US)

(21) Appl. No.: 14/528,722

(22) Filed: Oct. 30, 2014

(51) Int. Cl. F21V 29/83; F21V 31/00; F21V 29/67; F21V 23/00; F21V 29/74

(52) U.S. Cl. CPC F21V 29/83; F21V 23/003; F21V 29/74; F21V 29/67; F21V 31/005

(57) ABSTRACT

The disclosure relates to an illumination apparatus configured to expel internally-generated heat to keep light sources operating within a desirable temperature range to prevent damage to and prolong the operational life of the light sources. To effectuate heat removal, the apparatus includes a tubular structure defining a channel interposed between first and second ports, wherein the light sources are thermally coupled to the tubular structure. During operation, the light sources generate light and heat. The tubular structure is configured to draw the heat from the one or more light sources. The heat drawn by the tubular structure produces air convection within the channel such that air moves from the second port to the first port by way of the channel, or moves from the first port to the second port by way of the channel. One or more fans may be provided to generate forced air through the channel of the tubular structure.

### FIELD

This disclosure relates generally to illumination apparatuses, such as light bulbs and lighting fixtures, and in particular, to an illumination apparatus including a tubular heat sink for facilitating cooling by air convection or forced air.

### BACKGROUND

Illumination apparatuses, such as light bulbs and lighting fixtures, include at least one source for generating light. There are many types of light sources used in such illumination apparatuses. For instance, examples of different types of lights sources include light emitting diodes (LEDs), incandescent wire filaments, fluorescent tubes, high-intensity discharge bulbs, and others.

Generally, a power source is used to provide power (e.g., voltage and current) to the light source of an illumination apparatus. Typically, a portion of the power is used by the light source to emit light. Another portion of the power is incidentally generated by the light source as heat. Such heat may have adverse effects upon the light source and other components (e.g., ballast, driver, and/or other electronics (e.g., sensors, controllers, etc.)) of the illumination apparatus. Generally, the heat generated by the light source may undesirably damage or shorten the operational life of the light source, as well as to other components of the illumination apparatus.

Thus, there is a need for an illumination apparatus that facilitates the removal of heat from one or more light sources and other components to prevent damage to and extend the operational life of such components.

### SUMMARY

An aspect of the disclosure relates to an illumination apparatus that is configured to significantly expel internally-generated heat to keep one or more light sources operating within a desirable temperature range; and thus, prevent damage to and prolong the operational life of the one or more light sources.

In particular, the illumination apparatus comprises a tubular structure defining a first channel interposed between first and second ports. The illumination apparatus further comprises one or more light sources thermally coupled to the tubular structure. In response to receiving power, the one or more light sources generate light and heat. The tubular structure is configured to draw the heat from the one or more light sources. The heat drawn by the tubular structure produces air convection within the first channel such that air moves from the second port to the first port by way of the first channel, or moves from the first port to the second port by way of the first channel.

The tubular structure may be comprised of a relatively high thermally conductive material, such as a metal or high thermal conductive non-metal, in order to effectively draw heat from the one or more light sources. The tubular structure may be configured into many types of tubular shapes. For example, the tubular structure may have, throughout the entire height of the structure, a substantially uniform circular cross-section, a substantially uniform square cross-section, a substantially uniform rectangular cross-section, or a substantially uniform triangular cross-section. Alternatively, the tubular structure may be configured such that the width of the first channel varies along the height of the tubular structure.

The tubular structure may further include one or more fins situated within the first channel to further assist in the removal of heat from the one or more light sources. The fins may include an end attached to or integral with the interior side of the tubular structure, and extend towards the center of the first channel. The fins may be equally spaced angularly within the first channel, and extend the entire length of the channel.

The one or more light sources may be based on different types of lighting elements, including light emitting diodes (LEDs), incandescent filaments, LED filaments, fluorescent, high-intensity discharge, and others. In order to substantially maximize the thermal coupling to the tubular structure, the one or more light sources may be disposed on the exterior side of the tubular structure.

The illumination apparatus may further comprise a light passing housing (e.g., a translucent or transparent housing). The light passing housing may be configured to form a hermetically-sealed enclosure to house the one or more light sources therein. The hermetically-sealed enclosure may be formed by the mechanical coupling of the light passing housing to the tubular structure. The hermetically-sealed enclosure may be vacuumed sealed, and an inert gas (e.g., Helium (He)) may be introduced into the hermetically-sealed enclosure. The hermetically-sealed enclosure prevents or reduces the exposure of the one or more light sources to contaminates. The inert gas, Helium, which has a relatively high thermal conductivity for a gas, helps in the conduction of heat from the one or more light sources to the tubular structure and the light passing housing.

The light passing housing may comprises a tubular portion defining a second channel interposed between the second port of the tubular structure and a third port of the light passing housing. The heat generated by the one or more light sources produces air convection within the first and second channels such that air moves from the third port to the first port by way of the second channel, the second port, and the first channel, or moves from the first port to the third second port by way of the first channel, the second port, and the second channel.

The illumination apparatus may further comprise one or more conduits through which one or more wires are routed to supply the power to the one or more light sources. The one or more conduits may include one or more sealants in order to effectuate the hermetically-sealed enclosure provided at least partially by the light passing housing. The one or more conduits may be structurally integral with the tubular structure.

The illumination apparatus may further comprise a driver configured to generate a drive signal for supplying power to the one or more light sources. The driver may be configured to generate the drive signal from a power signal received from a power source. The illumination apparatus may further comprise a connector housing configured to mate with a connector (e.g., an E27 compliant socket, 2-pin, 3-pins, MR16, or others) of the power source. When properly mated, first and second terminals of the connector housing make electrical contact with corresponding terminals of the power source socket in order to bring the power signal to the driver. The connector housing may be configured to at least partially enclose the driver.

The illumination apparatus may further comprise one or more fans configured to generate force air through the channel of the tubular structure. Additionally, the illumination apparatus may further comprise a controller and a user interface, wherein the controller is configured to control a speed and direction of the one or more fans based on inputs received via the user interface.

Other aspects, advantages and novel features of the present disclosure will become apparent from the following detailed description of the disclosure when considered in conjunction with the accompanying drawings.

### BRIEF DESCRIPTION OF THE DRAWINGS

FIGS. 1A-1C illustrate top, side, and side cross-sectional views of an exemplary illumination apparatus in accordance with an aspect of the disclosure.

FIG. 2 illustrates a top view of another exemplary illumination apparatus in accordance with another aspect of the disclosure.

FIG. 3 illustrates a top view of another exemplary illumination apparatus in accordance with another aspect of the disclosure.

FIG. 4 illustrates a side cross-sectional view of another exemplary illumination apparatus in accordance with another aspect of the disclosure.

FIG. 5 illustrates a side cross-sectional view of another exemplary illumination apparatus in accordance with another aspect of the disclosure.

FIGS. 6A-6C illustrate top, side, and side cross-sectional views of another exemplary illumination apparatus in accordance with another aspect of the disclosure.

FIGS. 7A-7C illustrate side cross-sectional, inverted side cross-sectional, and bottom cross-sectional views of another exemplary illumination apparatus in accordance with another aspect of the disclosure.

FIGS. 8A-8B illustrate cross-sectional views of another illumination apparatus in different orientations in accordance with another aspect of the disclosure.

FIGS. 9A-9C illustrate top, side, and side cross-sectional views of another exemplary illumination apparatus in accordance with another aspect of the disclosure.

FIGS. 10A-10I illustrate first side, second side, first side cross-sectional, second side cross-sectional, top perspective, top, bottom perspective, bottom cross-sectional, and bottom views of another exemplary illumination apparatus in accordance with another aspect of the disclosure.

FIGS. 11A-11D illustrate bottom perspective, bottom cross-sectional, first side cross-sectional, and second side cross-sectional views of another exemplary illumination apparatus in accordance with another aspect of the disclosure.

FIGS. 12A-12I illustrate first side, second side, first side cross-sectional, second side cross-sectional, top perspective, top, bottom perspective, bottom cross-sectional, and bottom views of another exemplary illumination apparatus in accordance with another aspect of the disclosure.

FIG. 13 illustrates a side cross-sectional view of another exemplary illumination apparatus in accordance with another aspect of the disclosure.

FIGS. 14A-14D illustrate first side, second side, first side cross-sectional, second side cross-sectional, top perspective, top, bottom perspective, bottom cross-sectional, and bottom views of another exemplary illumination apparatus in accordance with another aspect of the disclosure.

FIGS. 15A-15C illustrate first side cross-sectional, second side cross-sectional, and bottom cross-sectional views of another exemplary illumination apparatus in accordance with another aspect of the disclosure.

### DETAILED DESCRIPTION OF THE EXEMPLARY EMBODIMENTS

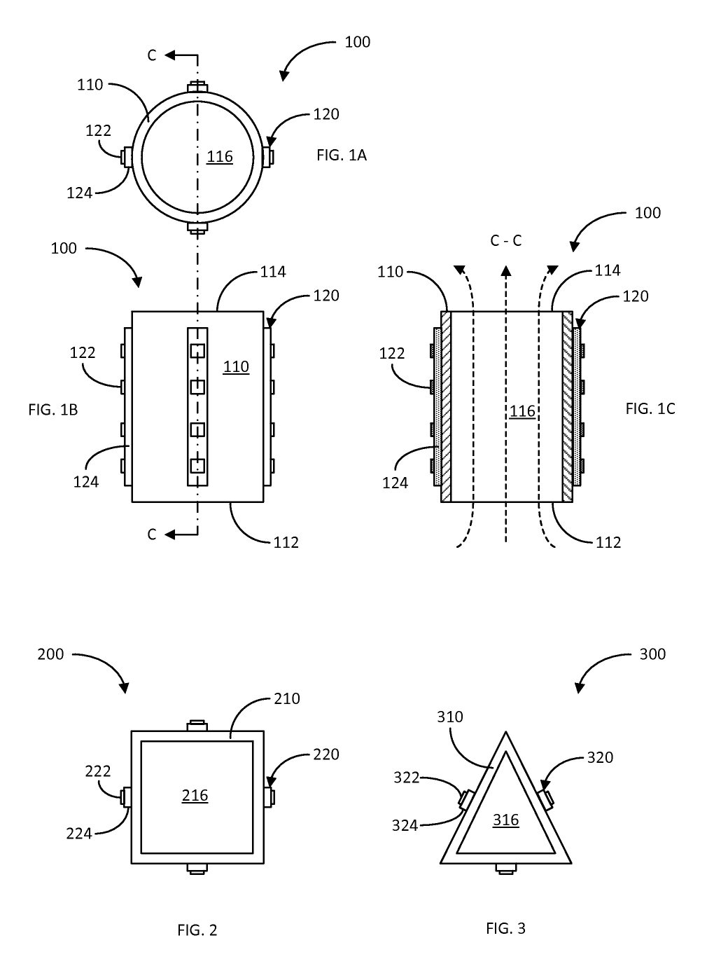

FIGS. 1A-1C illustrate top, side, and side cross-sectional views of an exemplary illumination apparatus 100 in accordance with an aspect of the disclosure. In summary, the illumination apparatus 100 includes a tubular structure or heat sink that facilitates removal of heat from the illumination apparatus. One or more light sources, which generate heat during illumination, are thermally coupled to the tubular structure. The tubular structure includes an air channel interposed between at least two (2) air ports.

In operation, the one or more light sources cause air within the channel to heat. The heated air rises due to convection, and exits the channel by way of one or more air ports. At the same time, cooler air situated below the channel is drawn into the channel by way of one or more air ports due to convection. Accordingly, the continuous rise and exit of the heated air within the channel, and the continuous drawing of cooler air into the channel facilitates the removal of heat from the illumination apparatus. This helps keep the components of the illumination apparatus cooler, and therefore, reduces the likelihood of damage to and extends the operational life of the components of the illumination apparatus.

In particular, with reference to FIGS. 1A-1C, the illumination apparatus 100 comprises a tubular structure 110. The tubular structure 110 defines an air channel 116 interposed between a first air port 112 and a second air port 114. The tubular structure 110 may be formed of a suitable thermal conducting material (e.g., greater than 10 watts per meter per Kelvin (W·m⁻¹·K⁻¹), such as metal (e.g., copper, aluminum, brass, bronze, silver, gold, tungsten, molybdenum, invar, kovar, etc.), a non-metallic heat conductor (e.g., graphite, carbon, diamond or diamond-coated, aluminum nitride, etc.), or a hybrid metal/non-metal material. In this example, the tubular structure 110 is substantially cylindrical in shape (e.g., has a substantially uniform circular cross-section). However, as it is discussed further herein, the tubular structure 110 may be configured into other shapes.

The illumination apparatus 100 further comprises one or more light sources 120. In this example, the one or more light sources 120 are each configured as an array of light emitting diodes (LEDs). For instance, each of the one or more light sources 120 comprises a plurality of LEDs 122 disposed on a substrate 124, such as a printed circuit board (PCB). Although the one or more light sources 120 are exemplified as LEDs, it shall be understood that the one or more light sources may be configured into other types of light sources, including, but not limited to, incandescent, fluorescent, high-intensity discharge, and others.

The one or more light sources 120 are thermally coupled to the tubular structure 110. In this example, the one or more light sources 120 are disposed on the exterior side of the tubular structure 110. For instance, as shown, the light sources 120 may be oriented substantially vertical on and equally spaced around the exterior side of the tubular structure 110. Although, as shown, the one or more light sources 120 are disposed on the exterior side of the tubular structure 110, they need not be, as long as the one or more light sources are thermally coupled to the tubular structure 110. Additionally, the light sources 120 may be oriented in other manners, such as in a horizontal manner and other manners.

In operation, when power (e.g., voltage and current) is supplied to the one or more light sources 120, the one or more light sources emit light and also generate heat. Due to its high thermal conductivity, the tubular structure 110 draws heat from the one or more light sources 120, which, in turn, causes the air within the channel 116 to heat. Due to convection, the heated air within the channel 116 rises and exits the channel by way of air port 114. At the same time, cooler air situated below the channel 116 is drawn into the channel by way of air port 112 due to convection. As shown by the dashed arrow lines in FIG. 1C, heated air within the channel 116 continuously rises and exits via air port 114, which is continuously replaced by cooler air being drawn into the channel via air port 112. This helps keep the one or more light sources 120 cooler or within a desirable temperature range, thereby reducing the likelihood of damage to and extending the operational life of the one or more light sources.

FIG. 2 illustrates a top view of another exemplary illumination apparatus 200 in accordance with another aspect of the disclosure. In the previous exemplary embodiment, the tubular structure 110 is configured substantially cylindrical in shape. In this example, the illumination apparatus 200 comprises a tubular structure 210 that has a substantially square or rectangular cross-section uniformly throughout its height. Similar to the previous embodiment, the tubular structure 210 is made out of a relatively high thermal conductive material, and defines an air channel 216 between a pair of air ports.

Also, similar to the previous embodiment, the illumination apparatus 200 further comprises one or more light sources 220 thermally coupled to the tubular structure 210. Similar to the previous example, the one or more light sources 220 are disposed on the exterior side of the tubular structure 210. For example, the light sources 220 are respectively disposed on the four (4) exterior sides of the tubular structure 210, and positioned thereon in a substantially vertical orientation, or in other orientations. In this example, the one or more light sources 220 are each configured as an array of LEDs 222 disposed on a substrate 224, such as a PCB. But, it shall be understood that the one or more light sources 220 may be configured into other types of light sources, as previously discussed.

The thermal management or cooling process of the previous illumination apparatus 100 operates in the same or similar manner in illumination apparatus 200. That is, as power is supplied to the one or more light sources 220 for illumination purposes, heat generated by the light sources is drawn away from the light sources by the tubular structure 210. As a consequence, the air within the channel 216 heats up, rises due to convection, and exits the upper air port. Cooler air below the tubular structure 210 is drawn into the channel 216 due to convection. The continuous moving of heated air away from the channel 216 and cooler air into the channel allows the one or more light sources 220 to remain cooler or within a more desirable temperature range.

FIG. 3 illustrates a top view of another exemplary illumination apparatus 300 in accordance with another aspect of the disclosure. In the previous exemplary embodiments, the tubular structures 110 and 210 are configured substantially cylindrical and square/rectangular in shape, respectively. In this example, the illumination apparatus 300 comprises a tubular structure 310 that has a substantially triangular cross-section uniformly throughout its height. Similar to the previous embodiments, the tubular structure 310 is made out of a relatively high thermal conductive material, and defines an air channel 316 between a pair of air ports.

Also, similar to the previous embodiments, the illumination apparatus 300 further comprises one or more light sources 320 thermally coupled to the tubular structure 310. Similar to the previous examples, the one or more light sources 320 are disposed on the exterior side of the tubular structure 310. For example, the light sources 320 are respectively disposed on the three (3) exterior sides of the tubular structure 310, and positioned thereon in a substantially vertical orientation, or in other orientations. In this example, the one or more light sources 320 are each configured as an array of LEDs 322 disposed on a substrate 324, such as a PCB. But, it shall be understood that the one or more light sources 320 may be configured into other types of light sources, as previously discussed.

The thermal management or cooling process of the previous illumination apparatuses 100 and 200 operates in the same or similar manner in illumination apparatus 300, as previously discussed. The exemplary illumination apparatuses 100, 200, and 300 illustrate that the tubular structure may have differently-shaped cross-section, as the principle of the cooling process performed by the tubular structure does not change with its cross-sectional shape. As discussed with reference to the following pair of exemplary embodiments, the cross-section of the tubular structure may vary along the longitudinal or vertical axis of the tubular structure.

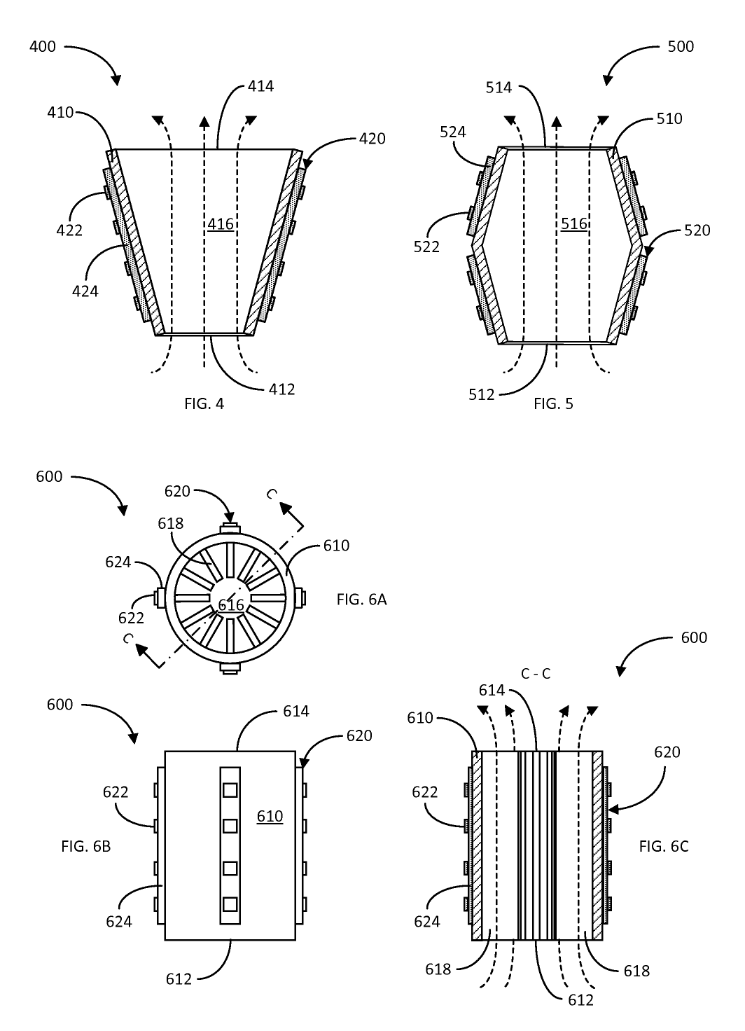

FIG. 4 illustrates a side cross-sectional view of another exemplary illumination apparatus 400 in accordance with another aspect of the disclosure. In the previous exemplary embodiments 100, 200, and 300, the cross-section of the corresponding tubular structure did not substantially vary along the height or longitudinal axis of the tubular structure (e.g., substantially circular, square/rectangle, or triangular cross-section throughout the entire height). In this example, the illumination apparatus 400 comprises a tubular structure 410 that has a cross-section that varies along its height or longitudinal axis. In particular, the tubular structure 410 has a cone shape. Similar to the previous embodiments, the tubular structure 410 is made out of a relatively high thermal conductive material, and defines an air channel 416 between a pair of air ports 412 and 414. Because the cone shaped tubular structure 410, the width of the channel 416 progressively increases from port 412 to port 414.

Similar to the previous embodiments, the illumination apparatus 400 further comprises one or more light sources 420 thermally coupled to the tubular structure 410. Similar to the previous examples, the one or more light sources 420 are disposed on the exterior side of the tubular structure 410. In this example, the one or more light sources 420 are each configured as an array of LEDs 422 disposed on a substrate 424, such as a PCB. But, it shall be understood that the one or more light sources 420 may be configured into other types of light sources, as previously discussed. Additionally, it shall be understood that the one or more light sources 420 may be oriented with respect to the tubular structure 410 in any manner, such as shown, or in other orientations including horizontal.

The thermal management or cooling process of the previous illumination apparatuses operates in the same or similar manner in illumination apparatus 400. That is, as power is supplied to the one or more light sources 420 for illumination purposes, heat generated by the light sources is drawn away from the light sources by the tubular structure 410. As a consequence, the air within the channel 416 heats up, rises due to convection, and exits the air port 414. Cooler air below the tubular structure 410 is drawn into the channel 416 due to convection. The continuous moving of heated air away from the channel 416 and cooler air into the channel, as indicated by the dashed arrow lines, allow the one or more light sources 420 to remain cooler or within a more desirable temperature range.

FIG. 5 illustrates a side cross-sectional view of another exemplary illumination apparatus 500 in accordance with another aspect of the disclosure. In the previous exemplary embodiment 400, the tubular structure 410 is configured in a cone shape, i.e., the diameter of the tubular structure progressively decreases or increases along its height. In this example, the illumination apparatus 500 comprises a tubular structure 510 that includes a first vertical section (e.g., extending half of the entire height) where the diameter of the tubular structure increases along its height, and a second vertical section (e.g., extending the other half of the entire height) where the diameter of the tubular structure decreases along its height. Similar to the previous embodiments, the tubular structure 510 is made out of a relatively high thermal conductive material, and defines an air channel 516 between a pair of air ports 512 and 514. The air ports 512 and 514 may be configured to have substantially the same size, or to have different sizes as desired.

Similar to the previous embodiments, the illumination apparatus 500 further comprises one or more light sources 520 thermally coupled to the tubular structure 510. Similar to the previous examples, the one or more light sources 520 are disposed on the exterior sides of the tubular structure 510. For example, the light sources 520 may be positioned on the exterior sides of the tubular structure 510 in a generally vertical orientation, or in other orientations. In this example, the one or more light sources 520 are each configured as an array of LEDs 522 disposed on a substrate 524, such as a PCB. But, it shall be understood that the one or more light sources 520 may be configured into other types of light sources, as previously discussed.

The thermal management or cooling process of the previous illumination apparatuses operates in the same or similar manner in illumination apparatus 500, as previously discussed. The exemplary illumination apparatuses 400 and 500 illustrate that the horizontal cross-section of the tubular structure may vary along the height of the structure, as the principle of the cooling process as performed by the tubular structure does not change with its varying horizontal cross-section.

FIGS. 6A-6C illustrate top, side, and side cross-sectional views of another exemplary illumination apparatus 600 in accordance with another aspect of the disclosure. In summary, the illumination apparatus 600 is similar to that of illumination apparatus 100 previously discussed, except that illumination apparatus 600 further comprises a plurality of fins mechanically coupled to or integral with the inner side of a tubular structure, and extending radially towards the center of the tubular structure. The plurality of fins improves the removal of heat from the illumination apparatus 600.

In particular, the illumination apparatus 600 comprises a tubular structure 610. In this example, the tubular structure 610 is configured into a cylindrical shape, but may be configured into other shapes, as previously discussed. The tubular structure 610 defines an air channel 616 situated between a pair of air ports 612 and 614. As in the previous embodiments, the tubular structure 610 is made out of a relatively high thermal conductive material, such as a metal or a high thermal conductive non-metal, as previously discussed.

The illumination apparatus 600 further comprises a plurality of fins 618 extending horizontally from an interior side of the tubular structure 610 radially towards the center of the tubular structure, and vertically along substantially the entire height of the tubular structure. The fins 618 may be attached to or integral with the tubular structure 610. The fins 618 may be uniformly spaced angularly around the channel 616 of the tubular structure 610. In this example, there are 12 fins, but it shall be understood that any number of fins may be implemented in the illumination apparatus 600. The fins 618 may also be made of a relatively high thermal conductive material, such as a metal or a high thermal conductive non-metal, as previously discussed. In this regard, the fins 618 may be made out of the same material as the tubular structure 610. The fins 618 may also be configured and/or oriented in other manners.

Similar to the previous embodiments, the illumination apparatus 600 further comprises one or more light sources 620. In this example, the one or more light sources 620 are each configured as array of light emitting diodes (LEDs). For instance, each of the one or more light sources 620 comprises a plurality of LEDs 622 disposed on a substrate 624, such as a PCB. Although the one or more light sources 620 are exemplified as LEDs, it shall be understood that the one or more light sources may be configured into other types of light sources, including, but not limited to, incandescent, fluorescent, high-intensity discharge, and others.

The one or more light sources 620 are thermally coupled to the tubular structure 610 and the fins 618. In this example, the one or more light sources 620 are disposed on the exterior side of the tubular structure 610. For instance, as shown, the light sources 620 may be oriented substantially vertical on and equally spaced around the exterior side of the tubular structure 610. Although, as shown, the one or more light sources 620 are disposed on exterior side of the tubular structure 610, they need not be, as long as the one or more light sources are thermally coupled to the tubular structure 610 and the fins 618. Additionally, the light sources 620 may be oriented in other manners, such as in a horizontal manner and other manners.

In operation, when power (e.g., voltage and current) is supplied to the one or more light sources 620, the one or more light sources emit light and also generate heat. Due to their high thermal conductivity, the tubular structure 610 draws heat from the one or more light sources 620, and the fins 618, in turn, draw heat from the tubular structure. Consequently, the air within the channel 616 is heated. Due to convection, the heated air within the channel 616 rises and exits the channel by way of air port 614. At the same time, cooler air situated below the channel 616 is drawn into the channel by way of air port 612 due to convection. As shown by the dashed arrow lines in FIG. 6C, heated air within the channel 616 continuously rises and exits via air port 614, which is continuously replaced by cooler air being drawn into the channel via air port 612. Because of the additional fins 618, the moving air within the channel 616 is exposed to more surface area of the combined heat sinking structure of the tubular structure 610 and the fins 618. This substantially improves the heat removal properties of the illumination apparatus 600 to help keep the one or more light sources 620 cooler, thereby reducing the likelihood of damage to and extending the operational life of the one or more light sources.

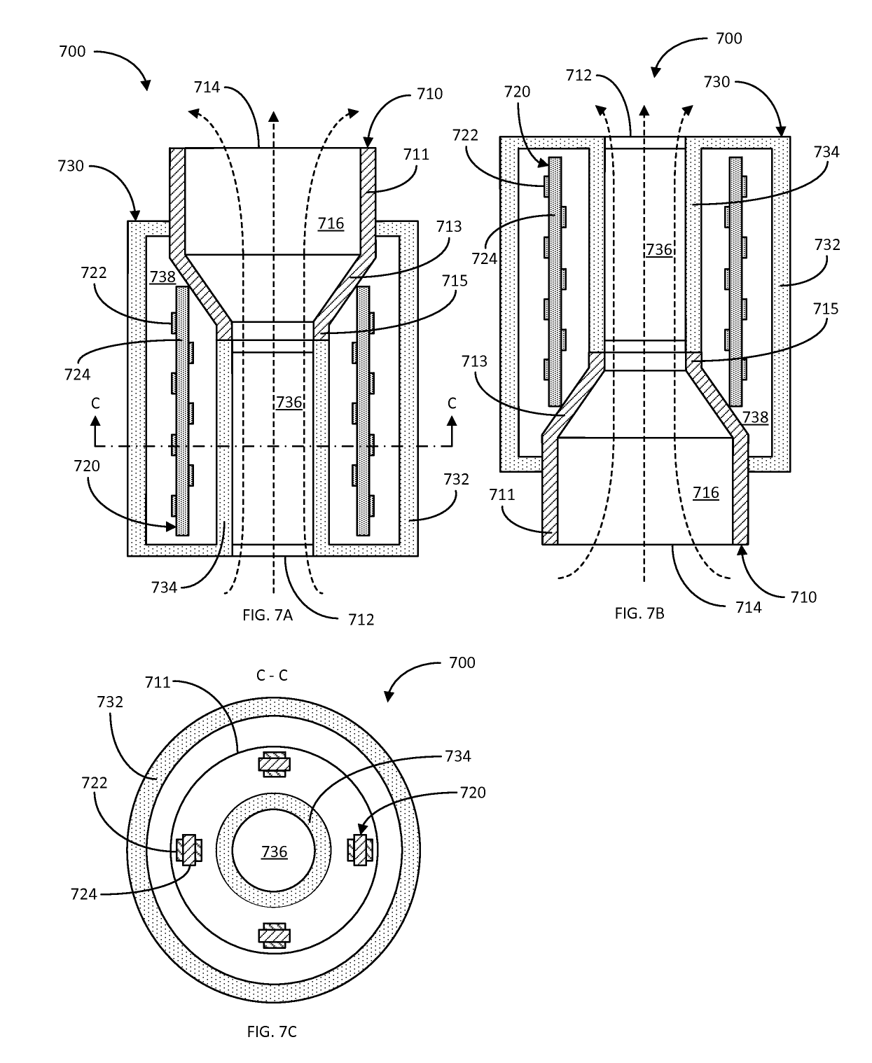

FIGS. 7A-7C illustrate side cross-sectional, inverted side cross-sectional, and bottom cross-sectional views of another exemplary illumination apparatus 700 in accordance with another aspect of the disclosure. In the previous embodiments, the one or more light sources are directly thermally coupled to the tubular structure. That is, the one or more light sources are either disposed on or sufficiently close to the tubular structure such that a majority of the heat generated by the one or more light sources is drawn to the tubular structure.

In illumination apparatus 700, the one or more light sources are positioned either generally below or above the tubular structure depending on the orientation of the illumination apparatus. In the case where the one or more light sources are positioned generally below the tubular structure, the one or more light sources heat the air below the tubular structure. The heated air rises due to convection, enters a channel defined by the tubular structure by way of an air port, and exits the channel by way of another airport. Cooler air from below replaces the rising heated air, and therefore, cools the illumination apparatus 700.

Similarly, in the case where the one or more light sources are positioned generally above the tubular structure, the one or more light sources heat the air above the tubular structure. The heated air rises due to convection. This causes cooler air below the tubular structure to be drawn into the channel of the tubular structure by way of an air port, and exits the channel by way of another airport. The movement of cooler air into the channel and out of the channel cools the illumination apparatus 700.

In particular, the illumination apparatus 700 comprises a tubular structure 710, one or more light sources 720, and a light passing housing 730 (e.g., a transparent or translucent housing). The light passing housing 730 is mated or mechanically coupled to the tubular structure 710 in a manner that defines a hermetically-sealed enclosure 738. The one or more light sources 720 are situated within the hermetically-sealed enclosure 738. The hermetically-sealed enclosure 738 may be filled with an inert gas, such as Helium (He), in order to reduce exposure of the one or more light sources 720 to contaminates that may damage or reduce the operational life of the one or more light sources. Helium (He) gas, in particular, has a relatively high thermal conductivity to better transfer heat from the one or more light sources 720 to the light passing housing 730 and the tubular structure 710. To effectuate the hermetically-sealed enclosure 730, a substantial vacuum may be formed in the enclosure 738 and then the inert gas introduced into the vacuumed sealed enclosure.

In this example, the tubular structure 710 is in the shape of a nozzle, and comprises a relatively large diameter section 711, a relatively small diameter section 715, and a middle section 713 that has a diameter that linearly decreases from the diameter of section 711 to the diameter of section 715. The tubular structure 710 defines an air channel 716. Similar to the previous embodiments, the tubular structure 710 may be comprised of a relatively high thermal conductive material (e.g., a metal or a high thermal conductive non-metal).

In this example, the light passing housing 730 comprises an outer wall 732 and an inner wall 734. As previously discussed, the light passing housing 730 may be comprised of a translucent or transparent material, such as glass, diffused glass, fused quartz, thermo plastics, polymers, and others. This allows the light generated by the one or more light sources 720 to pass through the walls, including the outer and inner walls 732 and 734, of the light passing housing 730. In this example, each of the one or more light sources 720 comprises LED arrays 722 disposed on both sides (e.g., bottom and top) of a substrate 724, such as a PCB. The substrate 724 may also be comprised of a transparent or translucent material in order to provide wider dispersion of light, such as in the case of a 4π light source.

The inner wall 734 of the light passing housing 730 may be configured into a tubular portion that defines another air channel 736 that is fluidly coupled to the air channel 716 of the tubular structure 710. That is, the tubular portion 734 of the light passing housing 730 is also coupled to the tubular structure 710 in a manner that defines a continuous air channel comprised of cascaded air channels 736 and 716. The tubular portion 734 of the light passing housing 720 also defines an air port 712 to allow external air to pass into or out of the channel 736. Similarly, the tubular structure 710 also defines an air port 714 to allow external air to pass into or out of the channel 716.

With specific reference to FIG. 7A, when power (e.g., voltage and current) is supplied to the one or more light sources 720, the one or more light sources emit light and also generate heat. Due to the relatively high thermal conductivity of the inert gas (e.g., He) in the hermetically-sealed enclosure 738, the light passing housing 730 and the tubular structure 710 draw heat from the one or more light sources 720. Consequently, the air within the channels 736 and 716 is heated. Due to convection, the heated air within the channels 736 and 716 rises and exits the channel 716 by way of air port 714. At the same time, cooler air situated below the channel 736 is drawn into the channel 736 by way of air port 712 due to convection. As shown by the dashed arrow lines in FIG. 7A, heated air within the cascaded channels 736 and 716 continuously rises and exits via air port 714, which is continuously replaced by cooler air being drawn into the cascaded channels 736 and 716 via air port 712. This air convection cooling process substantially improves the heat removal properties of the illumination apparatus 700 to help keep the one or more light sources 720 cooler or within a more desirable temperature range, thereby reducing the likelihood of damage to and prolonging the operational life of the one or more light sources.

The air convection cooling process works in basically the same or similar manner if the illumination apparatus is inverted as shown in FIG. 7B. That is, when power (e.g., voltage and current) is supplied to the one or more light sources 720, the one or more light sources emit light and also generate heat. Due to the relatively high thermal conductivity of the inert gas (e.g., He) in the hermetically-sealed enclosure 738, the tubular structure 710 and the light passing housing 730 draw heat from the one or more light sources 720. Consequently, the air within the channels 716 and 736 is heated. Due to convection, the heated air within the channels 716 and 736 rises and exits the channel 736 by way of air port 712. At the same time, cooler air situated below the channel 716 is drawn into the channel 716 by way of air port 714 due to convection. As shown by the dashed arrow lines in FIG. 7B, heated air within the cascaded channels 716 and 736 continuously rises and exits via air port 712, which is continuously replaced by cooler air being drawn into the cascaded channel 716 and 736 via air port 714. This air convection cooling process substantially improves the heat removal properties of the illumination apparatus 700 to maintain the one or more light sources 720 operating in a more desirable temperature range, thereby reducing the likelihood of damage to and prolonging the operational life of the one or more light sources. It shall be understood that the illumination apparatus 700 may be oriented in other manners including in a horizontal manner.

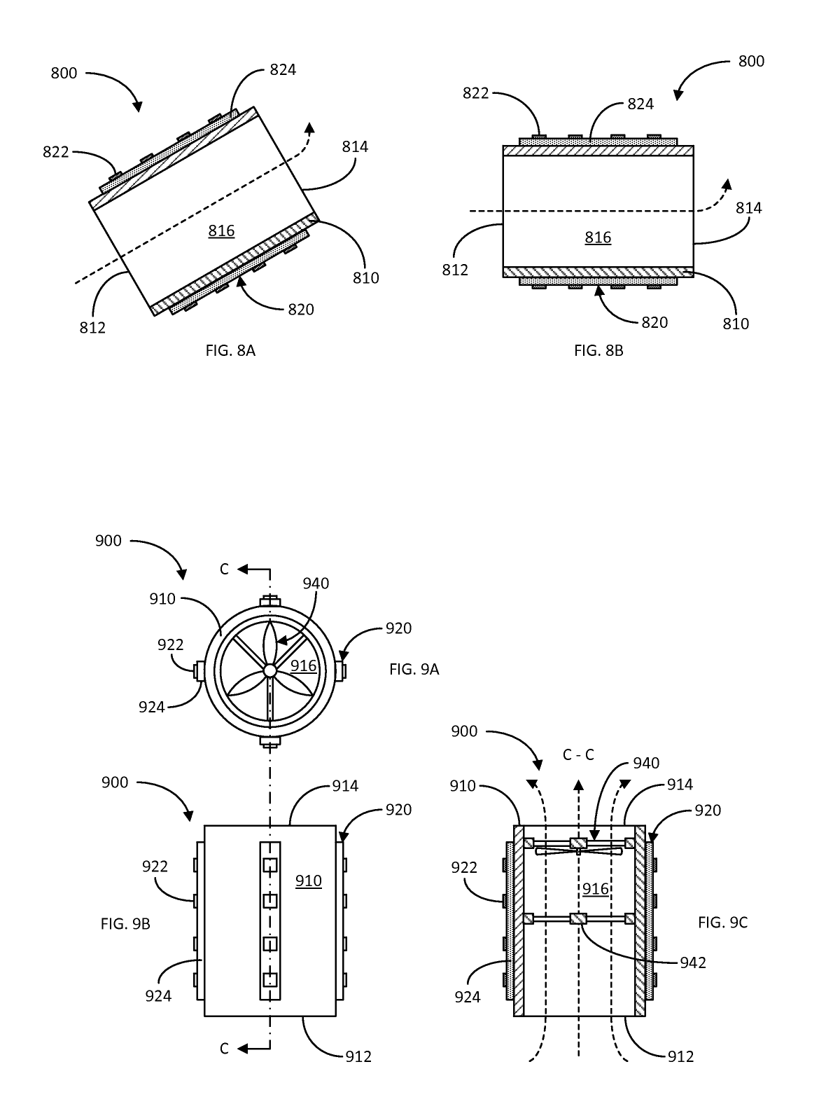

FIGS. 8A-8B illustrate cross-sectional views of another illumination apparatus 800 in different orientations in accordance with another aspect of the disclosure. This example is provided to illustrate that a tubular structure may be oriented in many different manners, including in an inclined manner and a horizontal manner.

In particular, the illumination apparatus 800 comprises a tubular structure 810 that may be oriented in an inclined manner as shown in FIG. 8A, and in a horizontal manner as shown in FIG. 8B. The tubular structure 810 comprises a relatively high thermal conductive material, such as a metal or a high thermal conductive non-metal, as previously discussed. The illumination apparatus 800 further comprises one or more light sources 820 thermally coupled to the tubular structure 810. For example, the one or more light sources 820 may be disposed on the various exterior walls of the tubular structure 810. In this example, the one or more light sources 820 may each be configured as an array of LEDs 822 disposed on a substrate 824. It shall be understood that the one or more light sources 820 may be configured into other types of light sources, as previously discussed.

The tubular structure 810 defines an air channel 816 between a first air port 812 and a second air port 814. The first air port 812 may be situated at one end of the tubular structure 810. The second air port 814 may be situated at the opposite end of the tubular structure 810. During operation, the one or more light sources 820 heat the air within the channel 816 of the tubular structure 810. Due to air convection and/or by forced air, cooler air enters the channel 816 by way of the first air port 812 and heated air exists the channel 816 by way of the second air port 814. The continuous flow of heated air out of the channel 816 by way of the second air port 814, and the continuous flow of cooler air into the channel by way of the first air port 812 help the one or more light sources 820 operate cooler or in a more desirable temperature range.

FIGS. 9A-9C illustrate top, side, and side cross-sectional views of another exemplary illumination apparatus 900 in accordance with another aspect of the disclosure. In this example, the illumination apparatus 900 comprises one or more fans to improve air flow through a tubular structure to facilitate the removal of heat from one or more light sources.

More specifically, the illumination apparatus 900 comprises a tubular structure 910 comprised of a relatively high thermal conductive material, as previously discussed. The tubular structure 910 defines an air channel 916 disposed between a first air port 912 and a second air port 914. The illumination apparatus 900 comprises a fan 940. For example, the fans 940 may be positioned to produced forced air through the channel 916. For instance, the fan 940 may be positioned coaxially within the channel 916 proximate the second air port 914 to pull heated air out of the channel through the second air port. The fan 940 may be configured to turn on when the one or more light sources 920 are turned on.

Alternatively, a temperature sensor 942 may be provided within the channel 916 for the purpose of controlling the fan 940 in response to the measured temperature within the channel. For instance, when the temperature within the channel 916 as measured by the temperature sensor 942 rises above a threshold, the fan 940 may be made to turn on to reduce the temperature within the channel. When the temperature within the channel 916 as measured by the temperature sensor 942 falls below the threshold, the fan 940 may be made to turn off for power saving purposes.

The illumination apparatus 900 further comprises one or more light sources 920 thermally coupled to the tubular structure 910. For example, the one or more light sources 920 may be disposed on the various exterior walls of the tubular structure 910. In this example, the one or more light sources 920 may each be configured as an array of LEDs 922 disposed on a substrate 924. It shall be understood that the one or more light sources 920 may be configured into other types of light sources, as previously discussed. The fan 940 produces forced air through the channel 916 to facilitate the removal of heat from the one or more light sources 920, to allow them to operate cooler or in a more desirable temperature range.

The following provides examples of commercial implementations of light bulbs that implement that aforementioned air convection cooling process.

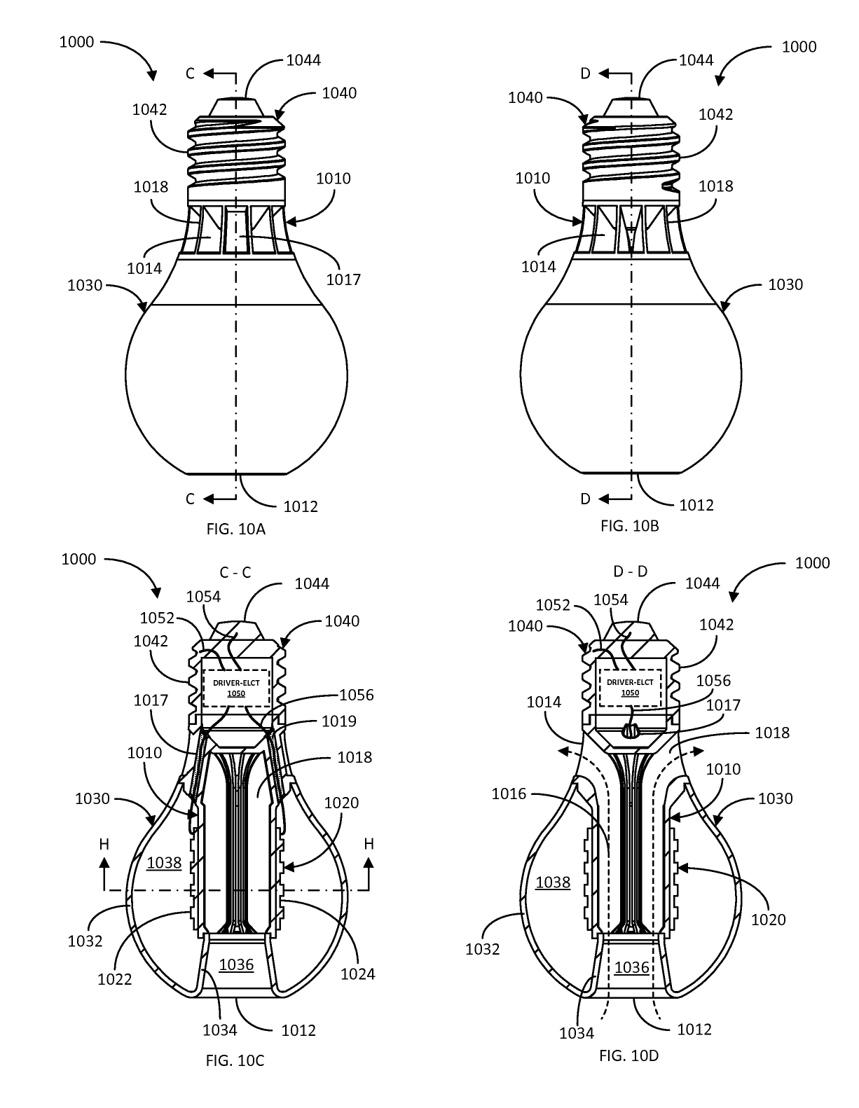

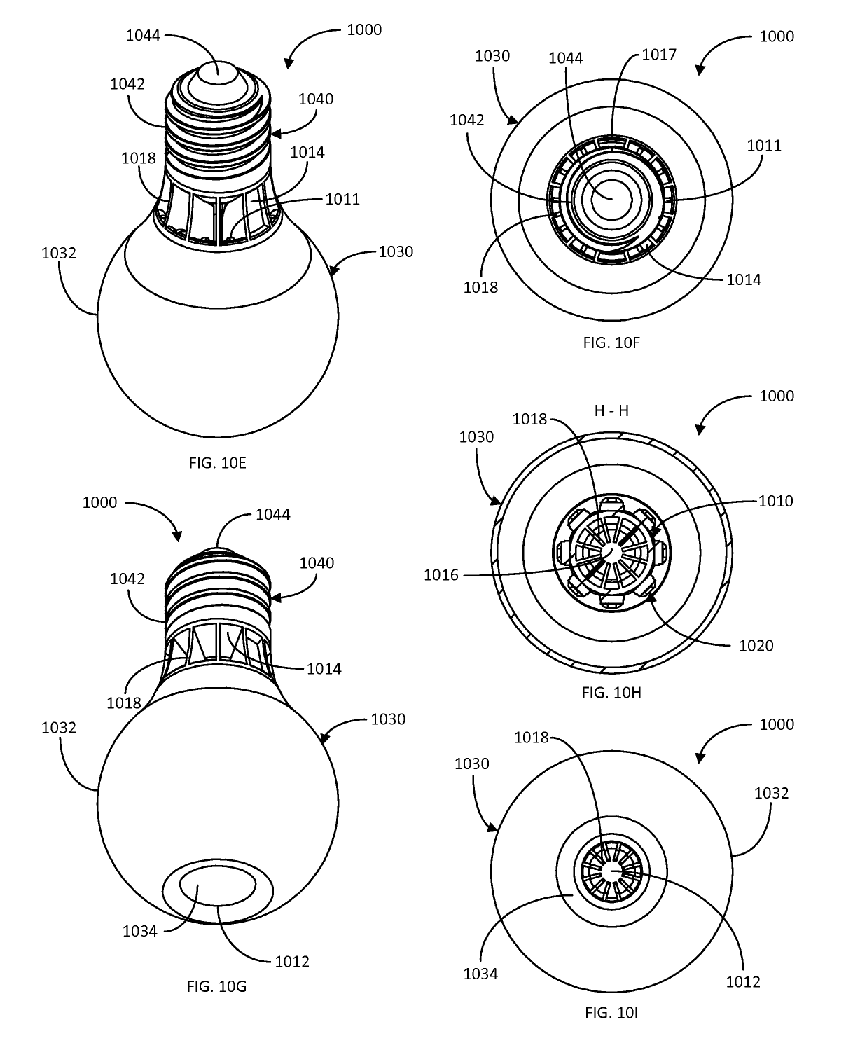

FIGS. 10A-10I illustrate first side, second side, first side cross-sectional, second side cross-sectional, top perspective, top, bottom perspective, bottom cross-sectional, and bottom views of another exemplary illumination apparatus 1000 in accordance with another aspect of the disclosure. In summary, the illumination apparatus 1000 is configured similar to an A-series light bulb, but includes a tubular structure and a light passing housing (an A-series shaped bulb) that define cascaded channels that allow external cooler air to enter the channels via an air port, and air heated by one or more light sources to exit the channels via another air port. As previous discussed, this air convection cooling process allows the one or more light sources to be operated in a more desirable temperature range in order to reduce the likelihood of damage to and prolong the operational life of the one or more light sources.

More specifically, with specific reference to FIGS. 10A-10B (See also, FIGS. 10E, 10F, 10G, and 10I for other perspectives), the illumination apparatus 1000 comprises a connector housing 1040, a tubular structure 1010, and a light passing housing 1030. The connector housing 1040 is configured to mate with a corresponding connector (e.g., socket) of a power source. For example, the connector housing 1040 may be configured to mate with any type of standard socket specified by the various international organizations, such as an E27, 2-pin, 3-pins, MR16 sockets that is commonly used in North America. The connector housing 1040 includes first and second terminals 1042 and 1044 for electrical connecting to corresponding terminals of a socket to which the connector housing mates.

The connector housing 1040 is mechanically coupled to the tubular structure 1010. As the connector housing 1040 and tubular structure 1010 may be configured generally cylindrical in shape, the connector housing is mechanically coupled to the tubular structure in a coaxial manner, and in a manner that their respective external surfaces form a substantially seamless exterior surface of the illumination apparatus 1000. However, it shall be understood that the connector housing 1040 and tubular structure 1010 may be configured into different shapes that need not form a seamless exterior surface.

Similarly, the tubular structure 1010 is mechanically coupled to the light passing housing 1030. As the tubular structure 1010 and the light passing housing 1030 may be configured generally cylindrical in shape, the tubular structure is mechanically coupled to the light passing housing in a coaxial manner, and in a manner that their respective external surfaces form a substantially seamless exterior surface of the illumination apparatus 1000. Similarly, it shall be understood that the tubular structure 1010 and the light passing housing 1030 may be configured into different shapes that need not form a seamless exterior surface.

With specific reference to FIGS. 10C-10D (See also, FIG. 10H, for other perspective), the connector housing 1040 is configured to house or enclose a driver and/or other electronics 1050. The driver and/or other electronics 1050 is configured to generate a drive signal for one or more light sources 1020 based on a power signal (e.g., voltage and current) received by way of the connector housing 1040. In this regard, the connector housing 1040 is configured to house or enclose wires 1052 and 1054 for electrically connecting the driver and/or other electronics 1050 to the terminals 1042 and 1044 of the connector housing. The connector housing 1040 is also configured to partially house or enclose one or more wires 1056 for electrically connecting the driver and/or other electronics 1050 to the one or more light sources 1020, respectively. It shall be understood that the connector housing 1040 may house or enclose other electronics related to the operation of the illumination apparatus 1000, such as for example electronics for controlling one or more fans if present.

Similar to the previous embodiments, the tubular structure 1010 may be comprised of a relatively high thermal conductive material (e.g., a metal or high thermal conductive non-metal). The tubular structure 1010 defines an air channel 1016 therein. The tubular structure 1010 further comprises a plurality of fins 1018 that extend horizontally from the interior side of the tubular structure radially towards the center of the tubular structure, and vertically substantially along the entire height of the air channel 1016. The plurality of fins 1018 may be mechanically attached to or integral with the tubular structure 1010. It shall be understood the fins 1018 may be configured and oriented in other manners.

The light passing housing 1030 may be attached to the tubular structure 1010 in a manner to form a hermetically-sealed enclosure 1038. In this regard, the lighting passing housing 1030 may be configured as an A-series shaped bulb comprising an outer wall 1032 that is configured to mate with an external wall of the tubular structure 1010 to form a hermetically sealed interface. Similarly, the light passing housing 1030 also includes an inner wall 1034 configured as a tubular portion that mates with a bottom portion of the tubular structure 1010 to form a hermetically sealed interface. The tubular structure 1010 includes one or more conduits 1017 through which the one or more wires 1056 extend to electrically connect the driver and/or other electronics 1050 to the one or more light sources 1020. The one or more conduits 1017 may be filled with a sealant 1019 in order to effectuate the hermetically sealed enclosure 1038. In this regard, a substantial vacuum may be formed in the enclosure 1038, then filled with an inert gas (e.g., He), and then the one or more sealants 1019 introduced into the one or more conduits 1017 in order to effectuate the hermetically sealed enclosure.

In this example, the one or more light sources 1020 each comprises an array of LEDs 1022 disposed on a substrate 1024. As with the previous embodiments, the one or more light sources 1020 may be configured into other types of light sources, as previously discussed. The one or more light sources 1020 are situated within the hermetically-sealed enclosure 1038 and are thermally coupled to the tubular structure 1010. For instance, the one or more light sources 1020 may be disposed on the exterior side of the tubular structure 1010.

In addition to the channel 1016, the tubular structure 1010 further defines an air port 1014 through which air passes into or out of the channel 1016. Additionally, the tubular portion 1034 of the light passing housing 1030 also defines a channel 1036 and an air port 1012. In this configuration, the light passing housing 1030 coaxially surrounds the channel 1036. The air channel 1036 defined by the tubular portion 1034 of the light passing housing 1030 is fluidly coupled to the air channel 1016 defined by the tubular structure 1010. Both air channels 1036 and 1016 are situated between air ports 1012 and 1014. For additional cooling, the tubular structure 1010 may further comprise a plurality of minor fins 1011 (See e.g., FIG. 10E) extending partially and vertically along the interior side of the tubular structure, wherein each minor fin is situated between adjacent fins 1018.

With specific reference to FIG. 10D, when power (e.g., voltage and current) is supplied to the one or more light sources 1020 by way of the connector housing 1040 and the driver and/or other electronics 1050, the one or more light sources emit light and also generate heat. Due to the relatively high thermal conductivity of the inert gas (e.g., He) in the hermetically-sealed enclosure 1038, the light passing housing 1030 and the tubular structure 1010 draw heat from the one or more light sources 1020. Consequently, the air within the channels 1036 and 1016 is heated. Due to convection, the heated air within the channels 1036 and 1016 rises and exits the channel 1016 by way of air port 1014. At the same time, cooler air situated below the channel 1036 is drawn into the channel 1036 by way of air port 1012 due to convection. As shown by the dashed arrow lines in FIG. 10D, heated air within the cascaded channels 1036 and 1016 continuously rises and exits via air port 1014, which is continuously replaced by cooler air being drawn into the cascaded channel 1036 and 1016 via air port 1012. This air convection cooling process substantially improves the heat removal properties of the illumination apparatus 1000 to help keep the one or more light sources 1020 within a desirable temperature range. This reduces the likelihood of damage to and prolongs the operational life of the one or more light sources 1020. The air convection cooling process works in basically the same or similar manner if the illumination apparatus 1000 is inverted or in other orientations.

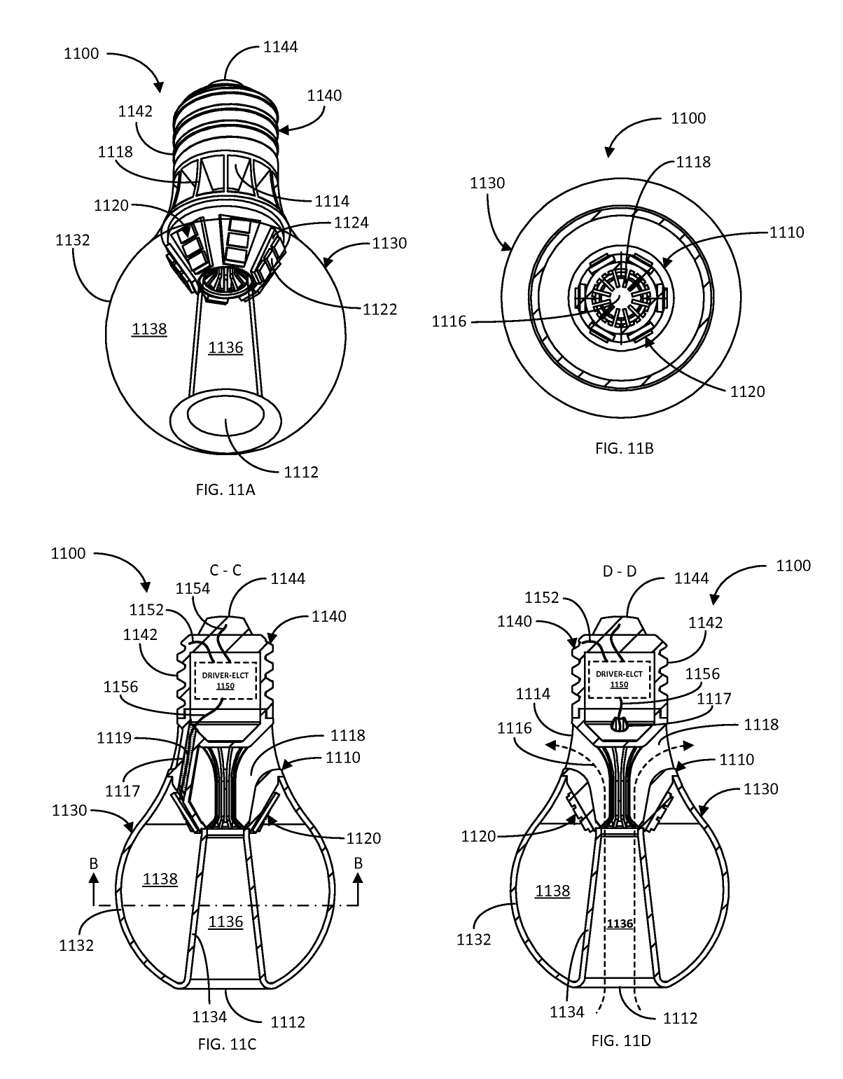

FIGS. 11A-11D illustrate bottom perspective, bottom cross-sectional, first side cross-sectional, and second side cross-sectional views of another exemplary illumination apparatus 1100 in accordance with another aspect of the disclosure. The illumination apparatus 1100 is similar to that of illumination apparatus 1000 previously discussed, and includes the same or similar elements as indicated by the same reference numbers, but with the most significant digit being a “11” instead of a “10.” The illumination apparatus 1100 differs from illumination apparatus 1000 in that illumination apparatus 1100 comprises a shorter tubular structure with a slanted exterior wall that orients the one or more light sources thereon to direct light at a desired downward/lateral angle. The illumination apparatus 1100 also includes a light passing housing comprising a longer tubular portion.

For the sake of completeness, the illumination apparatus 1100 comprises a connector housing 1140 for mating with a corresponding connector (e.g., socket) of a power source. The connector housing 1140 comprises first and second terminals 1142 and 1144 for electrically connecting to corresponding terminals of the power source socket. The connector housing 1140 encloses a driver and/or other electronics 1150 for supplying a drive signal to one or more light sources 1120 based on a power signal received from the power source. Alternatively, or in addition to, the connector housing 1140 may house other electronics, such as the fan controller, user interface circuitry, and possibly other electronics related to the operation of the illumination apparatus 1100.

The driver and/or other electronics 1150 receives the power signal by way of wires 1152 and 1154 electrically connected to the terminals 1142 and 1144 of the connector housing 1140, respectively. The driver and/or other electronics 1150 provides the drive signal to the one or more light sources 1120 by way of one or more wires 1156. The connector housing 1140 is coaxially attached to the tubular structure 1110 as previously discussed with respect to the previous embodiment.

The tubular structure 1110 is configured to define an air channel 1116 and an air port 1114. The tubular structure 1110 may further comprise a plurality of fins 1118 equally spaced around the channel 1116, and extending horizontally from the interior wall towards the center of the tubular structure, and vertically substantially along the entire length of the air channel 116. It shall be understood that the fins 1118 may be configured and/or oriented in other manners. The tubular structure 1110 further comprises one or more conduits 1117 through which the one or more wires 1156 extend to electrically connect the driver and/or other electronics 1150 to the one or more light sources 1120.

The light passing housing 1130 is configured to mate with the tubular structure to form a hermetically-sealed enclosure 1138. In this regard, the light passing housing 1130 may be configured as an A-series shaped bulb comprising an outer wall 1132 configured to mate with the tubular structure 1110 to form a hermetically sealed interface. Similarly, the light passing housing comprises an inner wall 1134 configured as a tubular portion that mates with the tubular structure 1110 to also form a hermetically sealed interface. The hermetically-sealed enclosure 1138 may be filled with an inert gas (e.g., He). In this regard, a substantial vacuum may be formed in the enclosure 1138, then filled with an inert gas (e.g., He), and then one or more sealants 1119 is introduced into the one or more conduits 1117 in order to effectuate the hermetically sealed enclosure.

In this example, the one or more light sources 1120 each comprises an array of LEDs 1122 disposed on a substrate 1124. As with the previous embodiments, the one or more light sources 1120 may be configured into other types of light sources, as previously discussed. The one or more light sources 1120 are situated within the hermetically-sealed enclosure 1138 and are thermally coupled to the tubular structure 1110. For instance, the one or more light sources 1120 may be disposed on the slanted exterior side of the tubular structure 1110. The slanted exterior side may be angled with respect to the longitudinal axis of the channel 1014 in any manner that the one or more light sources 1120 effectuate the desired illumination. The tubular portion 1134 of the light passing housing 1130 defines an air channel 1136 and an air port 1112. In this configuration, the light passing housing 1130 coaxially surrounds the channel 1136. The air channel 1136 is fluidly coupled to the air channel 1116 defined by the tubular structure 1110. Both air channels 1136 and 1116 are situated between air ports 1112 and 1114. The air cooling convection process of illumination apparatus 1100 operates in the same or similar manner as that of illumination apparatus 1000, previously discussed.

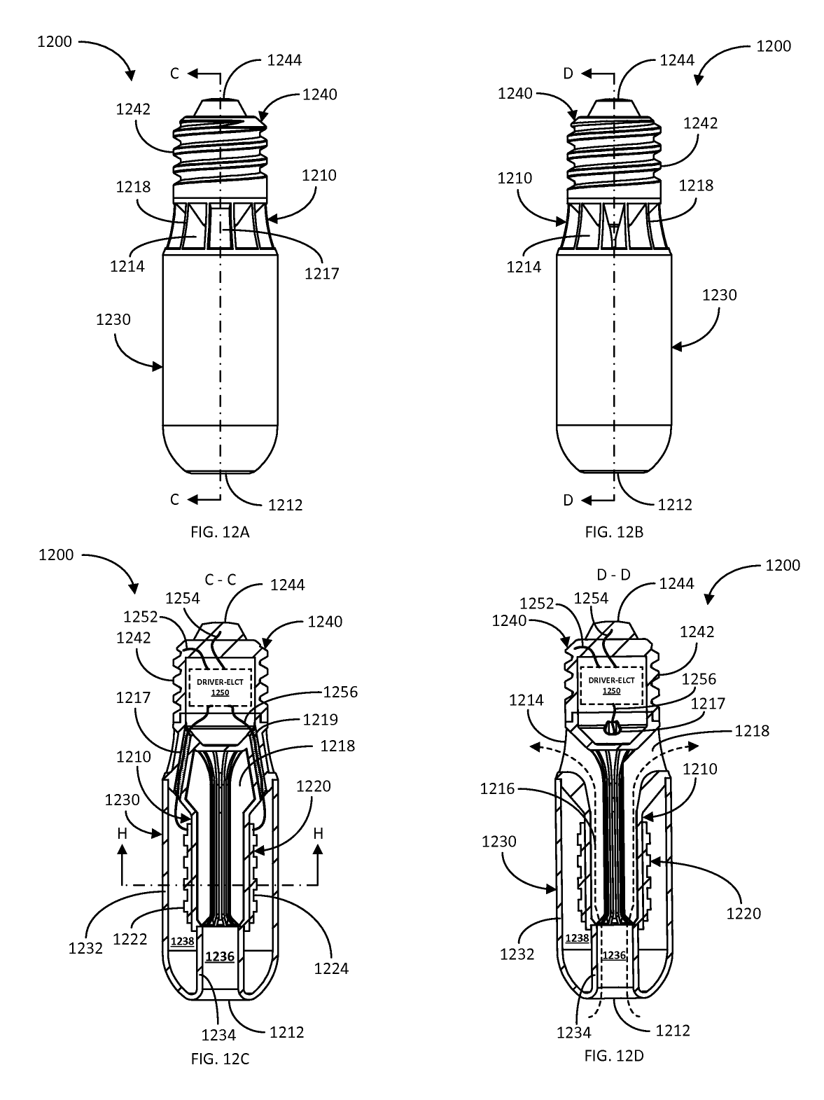

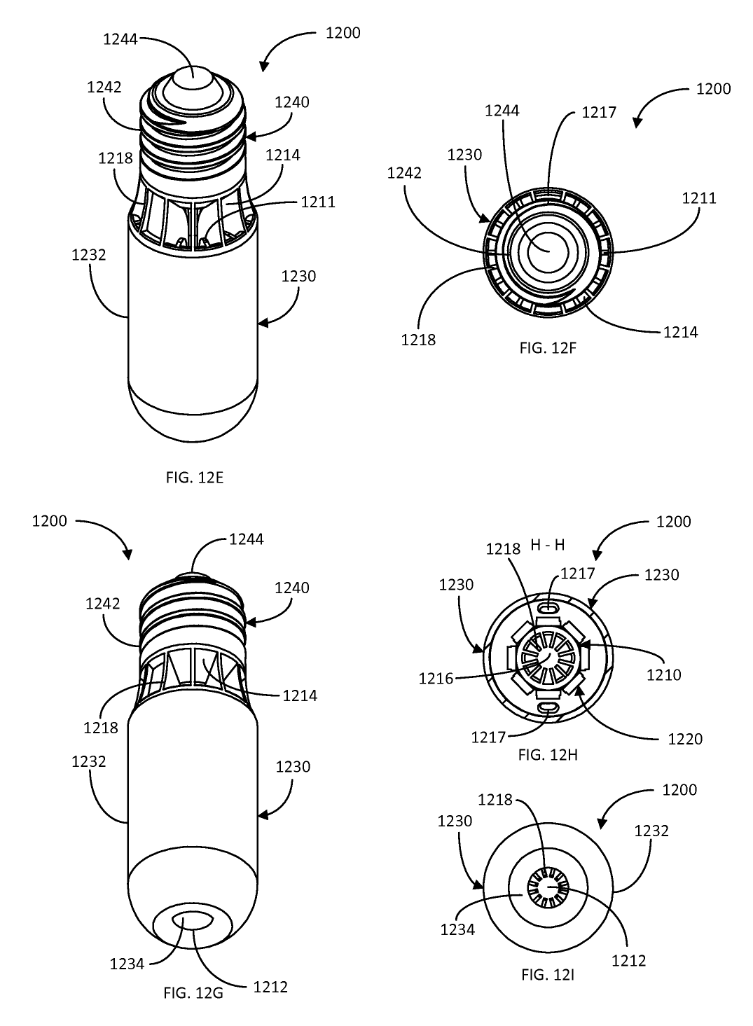

FIGS. 12A-12I illustrate first side, second side, first side cross-sectional, second side cross-sectional, top perspective, top, bottom perspective, bottom cross-sectional, and bottom views of another exemplary illumination apparatus 1200 in accordance with another aspect of the disclosure. The illumination apparatus 1200 is similar to that of illumination apparatus 1000 previously discussed, and includes the same or similar elements as indicated by the same reference numbers, but with the most significant digit being a “12” instead of a “10.” The illumination apparatus 1200 differs from illumination apparatus 1000 in that illumination apparatus 1200 comprises a T-series shape light passing housing 1230, instead of an A-series shaped light passing housing 1030 as in illumination apparatus 1000.

For the sake of completeness, the illumination apparatus 1200 comprises a connector housing 1240 for mating with a corresponding connector (e.g., socket) of a power source. The connector housing 1240 comprises first and second terminals 1242 and 1244 for electrically connecting to corresponding terminals of the power source socket. The connector housing 1240 encloses a driver and/or other electronics 1250 for supplying a drive signal to one or more light sources 1220 based on a power signal received from the power source. The driver and/or other electronics 1250 receives the power signal by way of wires 1252 and 1254 electrically connected to the terminals 1242 and 1244 of the connector housing 1240, respectively. The driver and/or other electronics 1250 provides the drive signal to the one or more light sources 1220 by way of one or more wires 1256. The connector housing 1240 is coaxially attached to the tubular structure 1210 as previously discussed with respect to the previous embodiment. Alternatively, or in addition to, the connector housing 1240 may house other electronics, such as the fan controller, user interface circuitry, and possibly other electronics related to the operation of the illumination apparatus 1200.

The tubular structure 1210 is configured to define an air channel 1216 and an air port 1214. The tubular structure 1210 may further comprise a plurality of fins 1218 equally spaced around the channel 1216, and extending horizontally from the interior wall towards the center of the tubular structure, and vertically substantially along the entire length of the air channel 1216. It shall be understood that the fins 1218 may be configured and/or oriented in other manners. The tubular structure 1210 further comprises one or more conduits 1217 through which the one or more wires 1256 extend to electrically connect the driver and/or other electronics 1250 to the one or more light sources 1220. For additional cooling, the tubular structure 1210 may further comprise a plurality of vertical minor fins 1211 (See e.g., FIG. 12E) extending partially and vertically along the interior side of the tubular structure, wherein each minor fin is situated between adjacent fins 1218.

The light passing housing 1230 is configured to mate with the tubular structure 1210 to form a hermetically-sealed enclosure 1238. In this regard, the light passing housing 1230 may be configured as a T-series (e.g., tubular) shaped bulb comprising an outer wall 1232 configured to mate with the tubular structure 1210 to form a hermetically sealed interface. Similarly, the light passing housing comprises an inner wall 1234 configured as a tubular portion that mates with the tubular structure 1210 to also form a hermetically sealed interface. The hermetically-sealed enclosure 1238 may be filled with an inert gas (e.g., He). In this regard, a substantial vacuum may be formed in the enclosure 1238, then filled with an inert gas (e.g., He), and then one or more sealants 1219 is introduced into the one or more conduits 1217 in order to effectuate the hermetically sealed enclosure 1238.

In this example, the one or more light sources 1220 each comprises an array of LEDs 1222 disposed on a substrate 1224. As with the previous embodiments, the one or more light sources 1220 may be configured into other types of light sources, as previously discussed. The one or more light sources 1220 are situated within the hermetically-sealed enclosure 1238 and are thermally coupled to the tubular structure 1210. For instance, the one or more light sources 1220 may be disposed on the exterior side of the tubular structure 1210. The tubular portion 1234 of the light passing housing 1230 defines an air channel 1236 and an air port 1212. In this configuration, the light passing housing 1230 coaxially surrounds the channel 1236. The air channel 1236 is fluidly coupled to the air channel 1216 defined by the tubular structure 1210. Both air channels 1236 and 1216 are situated between air ports 1212 and 1214. The air cooling convection process of illumination apparatus 1200 operates in the same or similar manner as that of illumination apparatus 1000, previously discussed.

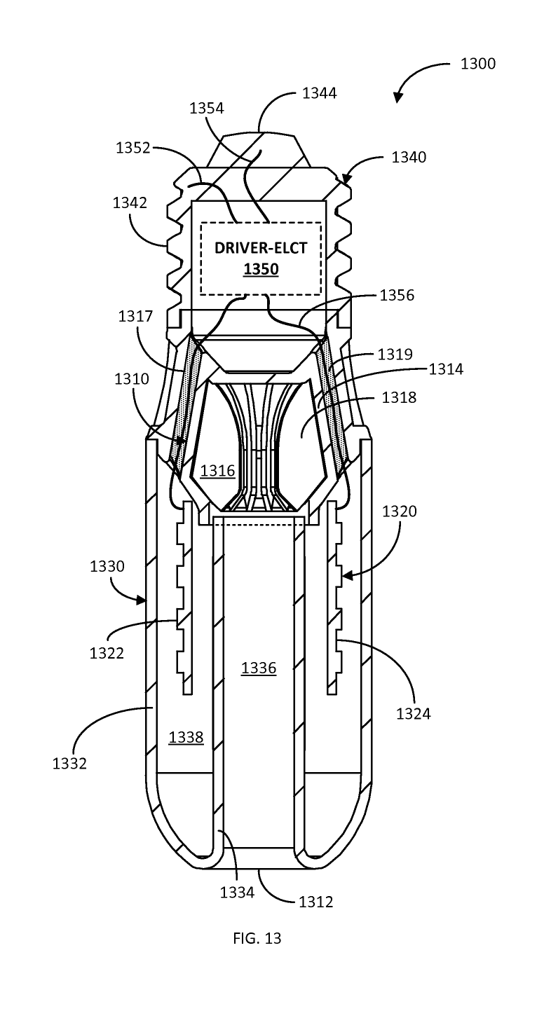

FIG. 13 illustrates a side cross-sectional view of another exemplary illumination apparatus 1300 in accordance with another aspect of the disclosure. The illumination apparatus 1300 is similar to that of illumination apparatus 1200, and includes the same or similar elements as indicated by the same reference numbers with the most significant digits being a “13” instead of a “12.” The illumination apparatus 1300 differs from illumination apparatus 1200 in that illumination apparatus 1300 comprises one or more light sources that are suspended within a hermetically-sealed enclosure of a light passing housing, and the tubular structure extends to approximately an upper end of the one or more light sources (e.g., a shorter tubular structure).

For the sake of completeness, the illumination apparatus 1300 comprises a connector housing 1340 for mating with a corresponding connector (e.g., socket) of a power source. The connector housing 1340 comprises first and second terminals 1342 and 1344 for electrically connecting to corresponding terminals of the power source socket. The connector housing 1340 encloses a driver and/or other electronics 1350 for supplying a drive signal to one or more light sources 1320 based on a power signal received from the power source. The driver and/or other electronics 1350 receives the power signal by way of wires 1352 and 1354 electrically connected to the terminals 1342 and 1344 of the connector housing 1340, respectively. The driver and/or other electronics 1350 provides the drive signal to the one or more light sources 1320 by way of one or more wires 1356. The connector housing 1340 is coaxially attached to the tubular structure 1310 as previously discussed with respect to the previous embodiments. Alternatively, or in addition to, the connector housing 1340 may house other electronics, such as the fan controller, user interface circuitry, and possibly other electronics related to the operation of the illumination apparatus 1300.

The tubular structure 1310 is configured to define an air channel 1316 and an air port 1314. The tubular structure 1310 may further comprise a plurality of fins 1318 equally spaced around the channel 1316, and extending horizontally from the interior wall towards the center of the tubular structure, and vertically substantially along the entire length of the air channel 1316. It shall be understood that the fins 1318 may be configured and/or oriented in other manners. The tubular structure 1310 further comprises one or more conduits 1317 through which the one or more wires 1356 extend to electrically connect the driver and/or other electronics 1350 to the one or more light sources 1320.

The light passing housing 1330 is configured to mate with the tubular structure 1310 to form a hermetically-sealed enclosure 1338. In this regard, the light passing housing 1330 may be configured as a T-series (e.g., tubular) shaped bulb comprising an outer wall 1332 configured to mate with the tubular structure 1310 to form a hermetically sealed interface. Similarly, the light passing housing 1330 comprises an inner wall 1334 configured as a tubular portion that mates with the tubular structure 1310 to also form a hermetically sealed interface. The hermetically-sealed enclosure 1338 may be filled with an inert gas (e.g., He). In this regard, a substantial vacuum may be formed in the enclosure 1338, then filled with an inert gas (e.g., He), and then one or more sealants 1319 is introduced into the one or more conduits 1317 in order to effectuate the hermetically sealed enclosure 1338.

In this example, the one or more light sources 1320 each comprises an array of LEDs 1322 disposed on a substrate 1324. As with the previous embodiments, the one or more light sources 1320 may be configured into other types of light sources, as previously discussed. The one or more light sources 1320 are suspended within the hermetically-sealed enclosure 1338. The tubular portion 1334 of the light passing housing 1330 defines an air channel 1336 and an air port 1312. In this configuration, the light passing housing 1330 coaxially surrounds the channel 1336. The air channel 1336 is fluidly coupled to the air channel 1316 defined by the tubular structure 1310. Both air channels 1336 and 1316 are situated between air ports 1312 and 1314. The air cooling convection process of illumination apparatus 1300 operates in the same or similar manner as that of illumination apparatuses 1100 and 1200, previously discussed.

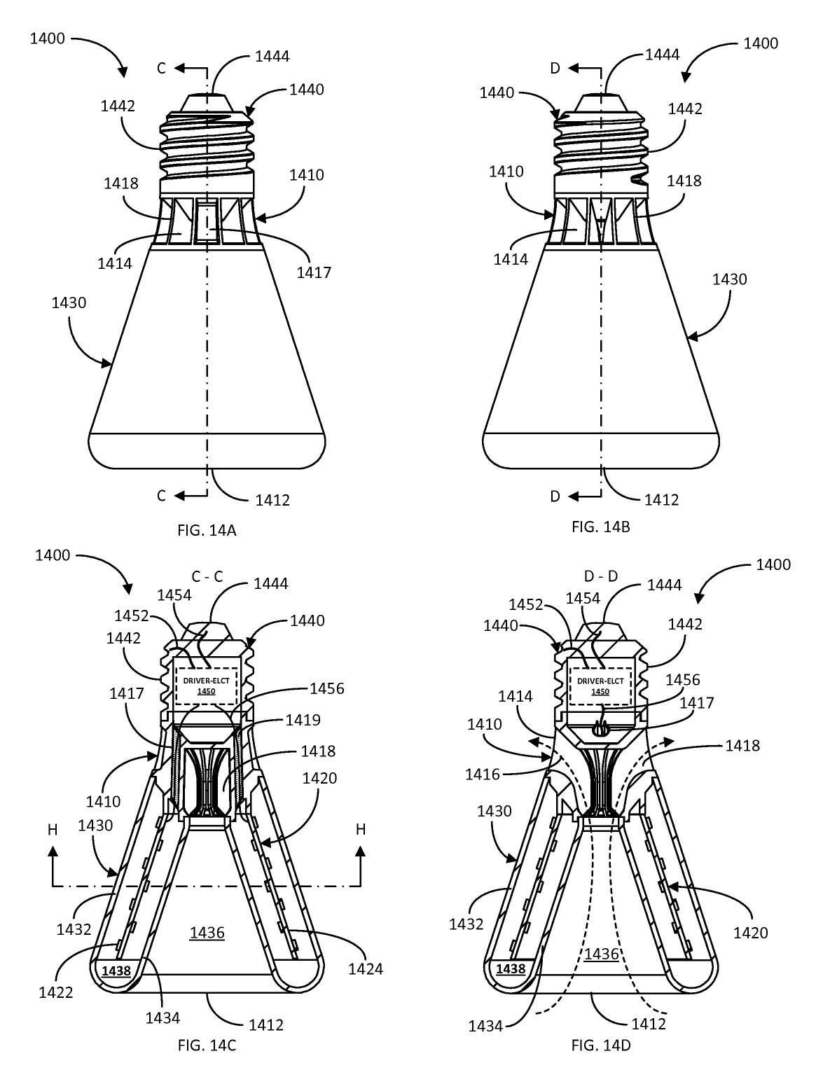

FIGS. 14A-14D illustrate first side, second side, first side cross-sectional, second side cross-sectional, top perspective, top, bottom perspective, bottom cross-sectional, and bottom views of another exemplary illumination apparatus 1400 in accordance with another aspect of the disclosure. The illumination apparatus 1400 is similar to that of illumination apparatus 1300 previously discussed, and includes the same or similar elements as indicated by the same reference numbers, but with the most significant digits being a “14” instead of a “13.” The illumination apparatus 1400 differs from illumination apparatus 1300 in that illumination apparatus 1400 comprises a conical shaped light passing housing instead of a tubular-shaped or T-series shaped light passing housing 1330.

For the sake of completeness, the illumination apparatus 1400 comprises a connector housing 1440 for mating with a corresponding connector (e.g., socket) of a power source. The connector housing 1440 comprises first and second terminals 1442 and 1444 for electrically connecting to corresponding terminals of the power source socket. The connector housing 1440 encloses a driver and/or other electronics 1450 for supplying a drive signal to one or more light sources 1420 based on a power signal received from the power source. The driver and/or other electronics 1450 receives the power signal by way of wires 1452 and 1454 electrically connected to the terminals 1442 and 1444 of the connector housing 1440, respectively. The driver and/or other electronics 1450 provides the drive signal to the one or more light sources 1420 by way of one or more wires 1456. The connector housing 1440 is coaxially attached to the tubular structure 1410 as previously discussed with respect to the previous embodiments. Alternatively, or in addition to, the connector housing 1440 may house other electronics, such as the fan controller, user interface circuitry, and possibly other electronics related to the operation of the illumination apparatus 1400.

The tubular structure 1410 is configured to define an air channel 1416 and an air port 1414. The tubular structure 1410 may further comprise a plurality of fins 1418 equally spaced around the channel 1416, and extending horizontally from the interior wall towards the center of the tubular structure, and vertically substantially along the entire length of the air channel. It shall be understood that the fins 1418 may be configured and/or oriented in other manners. The tubular structure 1410 further comprises one or more conduits 1417 through which the one or more wires 1456 extend to electrically connect the driver and/or other electronics 1450 to the one or more light sources 1420.

The light passing housing 1430 is configured to mate with the tubular structure 1410 to form a hermetically-sealed enclosure 1438. In this regard, the light passing housing 1430 may be configured as a conical shaped bulb comprising an outer wall 1432 configured to mate with the tubular structure 1410 to form a hermetically sealed interface. Similarly, the light passing housing 1430 comprises an inner wall 1434 configured as a tubular portion that mates with the tubular structure 1410 to also form a hermetically sealed interface. The hermetically-sealed enclosure 1438 may be filled with an inert gas (e.g., He). In this regard, a substantial vacuum may be formed in the enclosure 1438, then filled with an inert gas (e.g., He), and then one or more sealants 1419 is introduced into the one or more conduits 1417 in order to effectuate the hermetically sealed enclosure 1438.

In this example, the one or more light sources 1420 each comprises LED arrays 1422 disposed on both sides of a substrate 1424. The substrate 1424 may be transparent or translucent to increase the light dispersion characteristic of the light sources, as in a 4π light source. As with the previous embodiments, the one or more light sources 1420 may be configured into other types of light sources, as previously discussed. The one or more light sources 1420 are suspended within the hermetically-sealed enclosure 1438. The tubular portion 1434 of the light passing housing 1430 defines an air channel 1436 and an air port 1412. In this configuration, the light passing housing 1430 coaxially surrounds the channel 1436. The air channel 1436 is fluidly coupled to the air channel 1416 defined by the tubular structure 1410. Both air channels 1436 and 1416 are situated between air ports 1412 and 1414. The air cooling convection process of illumination apparatus 1400 operates in the same or similar manner as that of the previously-discussed illumination apparatuses.

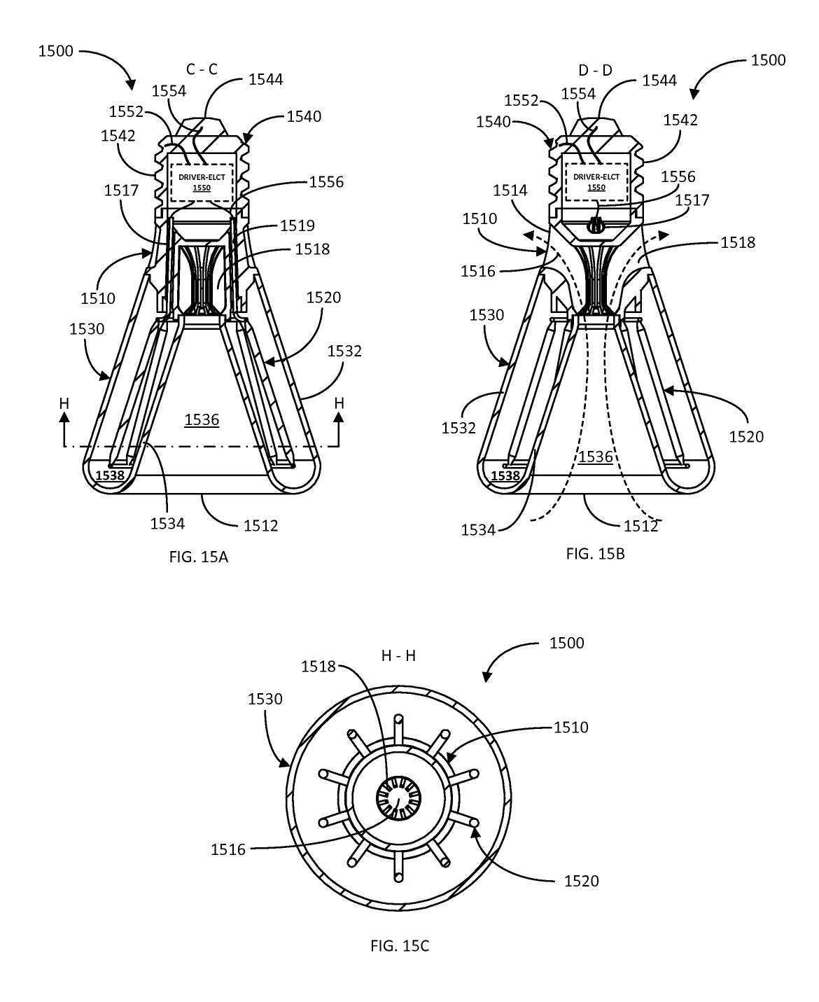

FIGS. 15A-15C illustrate first side cross-sectional, second side cross-sectional, and bottom cross-sectional views of another exemplary illumination apparatus in accordance with another aspect of the disclosure. The illumination apparatus 1500 is similar to that of illumination apparatus 1400 previously discussed, and includes the same or similar elements as indicated by the same reference numbers, but with the most significant digits being a “15” instead of a “14.” The illumination apparatus 1500 differs from illumination apparatus 1400 in that illumination apparatus 1500 comprises a filament type light source instead of a LED array on substrate type light source.

For the sake of completeness, the illumination apparatus 1500 comprises a connector housing 1540 for mating with a corresponding connector (e.g., socket) of a power source. The connector housing 1540 comprises first and second terminals 1542 and 1544 for electrically connecting to corresponding terminals of the power source socket. The connector housing 1540 encloses a driver and/or other electronics 1550 for supplying a drive signal to one or more light sources 1520 based on a power signal received from the power source. The driver and/or other electronics 1550 receives the power signal by way of wires 1552 and 1554 electrically connected to the terminals 1542 and 1544 of the connector housing 1540, respectively. The driver and/or other electronics 1550 provides the drive signal to the one or more light sources 1520 by way of one or more wires 1556. The connector housing 1540 is coaxially attached to the tubular structure 1510 as previously discussed with respect to the previous embodiments. Alternatively, or in addition to, the connector housing 1540 may house other electronics, such as the fan controller, user interface circuitry, and possibly other electronics related to the operation of the illumination apparatus 1500.

The tubular structure 1510 is configured to define an air channel 1516 and an air port 1514. The tubular structure 1510 may further comprise a plurality of fins 1518 equally spaced around the channel 1516, and extending horizontally from the interior wall towards the center of the tubular structure, and vertically substantially along the entire length of the air channel. It shall be understood that the fins 1418 may be configured and/or oriented in other manners. The tubular structure 1510 further comprises one or more conduits 1517 through which the one or more wires 1556 extend to electrically connect the driver and/or other electronics 1550 to the one or more light sources 1520.

The light passing housing 1530 is configured to mate with the tubular structure 1510 to form a hermetically-sealed enclosure 1538. In this regard, the light passing housing 1530 may be configured as a conical shaped bulb comprising an outer wall 1532 configured to mate with the tubular structure 1510 to form a hermetically sealed interface. Similarly, the light passing housing 1530 comprises an inner wall 1534 configured as a tubular portion that mates with the tubular structure 1510 to also form a hermetically sealed interface. The hermetically-sealed enclosure 1538 may be filled with an inert gas (e.g., He). In this regard, a substantial vacuum may be formed in the enclosure 1538, then filled with an inert gas (e.g., He), and then one or more sealants 1519 is introduced into the one or more conduits 1517 in order to effectuate the hermetically sealed enclosure 1538.

In this example, the one or more light sources 1520 each comprises a filament, such as an incandescent filament, LED filament, and others. The one or more light sources 1520 are suspended within the hermetically-sealed enclosure 1538. The tubular portion 1534 of the light passing housing 1530 defines an air channel 1536 and an air port 1512. In this configuration, the light passing housing 1530 coaxially surrounds the channel 1536. The air channel 1536 is fluidly coupled to the air channel 1516 defined by the tubular structure 1510. Both air channels 1536 and 1516 are situated between air ports 1512 and 1514. The air cooling convection process of illumination apparatus 1500 operates in the same or similar manner as that of the previously-discussed illumination apparatuses.

While the invention has been described in connection with various embodiments, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. An illumination apparatus, comprising:
a tubular structure defining a first channel interposed between a first port and a second port; and
one or more light sources thermally coupled to the tubular structure, wherein the one or more light sources generate light and heat in response to receiving power, wherein the heat generated by the one or more light sources produces air convection within the first channel such that air moves from the second port to the first port by way of the first channel, or moves from the first port to the second port by way of the first channel.

2. The illumination apparatus of claim 1, wherein the tubular structure comprises a substantially uniform circular cross-section, a substantially uniform square cross-section, a substantially uniform rectangular cross-section, or a substantially uniform triangular cross-section, throughout a height of the tubular structure.

3. The illumination apparatus of claim 1, further comprising one or more fins situated within the first channel of the tubular structure.

4. The illumination apparatus of claim 3, wherein the fins each extend from an interior side of the tubular structure towards a center of the first channel.

5. The illumination apparatus of claim 1, wherein the one or more light sources are disposed on an exterior side of the tubular structure.

6. The illumination apparatus of claim 1, further comprising a light passing housing, wherein the light passing housing is mechanically coupled to the tubular structure in a manner that forms a hermetically-sealed enclosure, wherein the one or more light sources are situated within the hermetically sealed enclosure.

7. The illumination apparatus of claim 6, wherein the light passing housing comprises a tubular portion defining a second channel interposed between the second port and a third port, wherein the heat generated by the one or more light sources produces air convection within the first and second channels such that air moves from the third port to the first port by way of the second channel, the second port, and the first channel, or moves from the first port to the third second port by way of the first channel, the second port, and the second channel.

8. The illumination apparatus of claim 6, further comprising one or more conduits through which one or more wires are routed to supply the power to the one or more light sources, wherein the one or more conduits comprises one or more sealants configured to effectuate the hermetically-sealed enclosure.

9. The illumination apparatus of claim 8, wherein the one or more conduits are integral with the tubular structure.

10. The illumination apparatus of claim 1, wherein at least one of the one or more light sources comprises an array of light emitting diodes (LEDs) disposed on a substrate, an incandescent filament, an LED filament, a fluorescent light medium, or a high intensity discharge light medium.

11. The illumination apparatus of claim 1, further comprising a driver configured to generate a drive signal for supplying the power to the one or more light source, wherein the driver generates the drive signal from a power signal received from a power source.

12. The illumination apparatus of claim 11, further comprising a connector housing including first and second terminals, wherein the connector housing is configured to mate with a corresponding connector of a power source such that the first and second terminals make electrical contact with corresponding terminals of the corresponding connector of the power source, wherein the connector housing at least partially encloses the driver, and wherein the driver is electrically coupled to the first and second terminals of the connector housing.

13. The illumination apparatus of claim 1, further comprising one or more fans configured to generate forced air through the channel of the tubular structure.

14. The illumination apparatus of claim 13, further comprising a temperature sensor configured to generate a signal indicative of a temperature within the first channel, wherein the fan operates based on the temperature signal.

15. An illumination apparatus, comprising:
a tubular structure defining a first channel interposed between a first port and a second port;
a light passing housing mechanically coupled to the tubular structure, wherein the light passing housing comprises a tubular portion defining a second channel interposed between the second port and a third port; and
one or more light sources situated within the light passing housing, wherein the one or more light sources generate light and heat in response to receiving power, wherein the heat generated by the one or more light sources produces air convection within the first and second channels such that air moves from the third port to the first port by way of the second channel, the second port, and the first channel, or moves from the first port to the third second port by way of the first channel, the second port, and the second channel.

16. The illumination apparatus of claim 15, wherein the light passing housing is configured to form a hermetically-sealed enclosure, wherein the one or more light sources are situated within the hermetically sealed enclosure.

17. The illumination apparatus of claim 16, wherein the tubular structure comprises one or more conduits through which one or more wires are routed for supplying the power to the one or more light sources, wherein the one or more conduits comprises one or more sealants to effectuate the hermetically sealed enclosure.

18. The illumination apparatus of claim 16, wherein the light passing housing is configured as an A-series shaped bulb that coaxially surrounds the second channel defined by the tubular portion of the light passing housing.

19. The illumination apparatus of claim 16, wherein the light passing housing is configured as a T-series shaped bulb that coaxially surrounds the second channel defined by the tubular portion of the light passing housing.

20. The illumination apparatus of claim 16, wherein the light passing housing is configured as an conical shaped bulb that coaxially surrounds the second channel defined by the tubular portion of the light passing housing.

21. An illumination apparatus, comprising:
a connector housing comprising first and second terminals, wherein the connector housing is configured to mate with a socket of a power source such that the first and second terminals make electrical contact with corresponding terminals of the socket;
a driver configured to generate a drive signal from a power signal generated by the power source, wherein the driver is at least partially situated within the connector housing, and wherein the driver is configured to receive the power signal by way of the first and second terminals of the connector housing;
a tubular structure defining a first channel interposed between first and second ports, wherein the tubular structure is mechanically coupled to the connector housing;
a light passing housing mechanically coupled to the tubular structure in a manner that forms a hermetically-sealed enclosure, wherein the hermetically-sealed enclosure is filled with an inert gas, and wherein the light passing housing comprises a tubular portion defining a second channel interposed between the second port and a third port;
one or more light sources situated within the hermetically-sealed enclosure, wherein the one or more light sources is configured to generate light and heat in response to the drive signal, wherein the heat generated by the one or more light sources is configured to produce air convection within the first and second channels such that air moves from the third port to the first port by way of the second channel, the second port, and the first channel, or moves from the first port to the third port by way of the first channel, the second port, and the second channel; and
one or more conduits through which wires extend to provide the drive signal from the driver to the one or more light sources, wherein the one or more conduits comprise one or more sealants to effectuate the hermetically-sealed enclosure.
